(19) United States
(12) Patent Application Publication
(10) Pub. No.: US 2007/0001652 A1
(43) Pub. Date: Jan. 4, 2007

(54) Multi-power supply circuit and multi-power supply method

(75) Inventor: Yasushige Ogawa, Kasugai (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED

(21) Appl. No.: 11/431,882

(22) Filed: May 11, 2006

(30) Foreign Application Priority Data
Jul. 4, 2005 (JP) 2005-195055

(51) Int. Cl. G05F 1/613

(52) U.S. Cl. 323/224

(57) ABSTRACT

The present invention aims to provide a multi-power supply circuit capable of generating multi-power efficiently and reducing power consumption, and a multi-power supply method therefor. A supply voltage is output from a DCDC converter. Output transistors of linear regulators are series-connected to a power supply path between a resistive element and the DCDC converter. That is, a bias current path is shared between the linear regulators and the corresponding path is taken as one. With the supply voltage as the reference, supply voltages corresponding to intermediate negative voltages between the supply voltage and a reference voltage are generated by the linear regulators. A bias current consumed by the multi-power supply circuit is held constant as a bias current i regardless of the number of the linear regulators.

### CROSS-REFERENCE TO RELATED APPLICATIONS

This application is based upon and claims the benefit of priority from the prior Japanese Patent Application No. 2005-195055 filed on Jul. 4, 2005, the entire contents of which are incorporated herein by reference.

### BACKGROUND OF THE INVENTION

1. Field of the Invention

The present invention relates to a multi-power supply circuit and a multi-power supply method, and particularly to a multi-power supply circuit and a multi-power supply method capable of generating multi-power with satisfactory efficiency and reducing power consumption.

2. Description of Related Art

There has recently been a demand for power saving of portable electronic equipment and a semiconductor device. On the other hand, an internal power supply voltage to be used has been brought into multi-power form due to an increase in complexity. It is important to generate these plural power supply voltages with good efficiency even in terms of a reduction in current consumption of the semiconductor device or the like.

An electronic apparatus equipped with a combination of a DC/DC converter and series regulators has been disclosed in Japanese unexamined patent publication No. 2001-211640 shown in FIG. 3. When an internal circuit 101 is placed in an active state, a power control unit 113 operates a switching generator 120 to supply an output power supply voltage Vddi to a third series regulator 160. When the internal circuit 101 is placed in a standby state, the power control unit 113 stops the switching generator 120 and at the same time operates a first series regulator 130 to supply an output power supply voltage Vddi to the third series regulator 160. The third series regulator 160 steps down the output power supply voltage Vddi to an internal power supply voltage VddL.

The first series regulator 130 comprises a voltage comparator 131, a P channel type MOSFET 133 operated as a variable resistor, a resistor 136 and an N channel type switch MOSFET 137 which allow a bias current of the P channel type MOSFET 133 to flow therethrough, and a P channel type switch MOSFET 135. Similarly, the third series regulator 160 is equipped with a resistor 166 and an N channel type switch MOSFET 167 which allow a bias current of a P channel type MOSFET 163 to flow therethrough.

When a signal S114 is low in level, the N channel type switch MOSFET 137 is brought to an off state, the P channel type switch MOSFET 135 is brought to an on state and the P channel type MOSFET 133 is brought to an off state, so that the output of the first series regulator 130 is brought into a high impedance state. On the other hand, when the signal S114 is high in level, the N channel type switch MOSFET 137 is brought to an on state and the P channel type switch MOSFET 135 is brought to an off state. Even in the third series regulator 160, a similar operation is performed according to a signal S116.

Incidentally, Japanese unexamined patent publication No. 2001-236131, Japanese unexamined patent publication No. H10(1998)-225109, Japanese unexamined patent publication No. H11(1999)-353040, and Japanese unexamined patent publication No. 2004-147391 have been disclosed as the above related arts.

### SUMMARY OF THE INVENTION

In Japanese unexamined patent publication No. 2001-211640 shown in FIG. 3, however, a bias current path constituted of the resistor 136 and the N channel type switch MOSFET 137 exists in the first series regulator 130. A bias current path constituted of the resistor 166 and the N channel type switch MOSFET 167 exists in the third series regulator 160. That is, the paths for allowing the bias currents to flow therethrough exist every series regulators. In doing so, a problem arises in that when the number of series regulators is increased for the purpose of more multi-power, the bias current paths increase in number depending upon the increase in regulator, and an increase in current consumption due to the increase in the number of these paths cannot be neglected.

The present invention has been made to solve at least one of the problems of the background art. An object of the present invention is to provide a multi-power supply circuit and a multi-power supply method capable of generating multi-power with good efficiency and reducing power consumption.

To achieve the above object, a multi-power supply circuit according to the present invention comprises: a voltage generating unit for generating a predetermined voltage; at least two linear regulators; and a resistive element for applying a bias current to each of the linear regulators, wherein output transistors provided in the linear regulators are series-connected to a power supply path between the resistive element and the voltage generating unit.

The voltage generating unit generates a predetermined voltage. As the predetermined voltage, a negative voltage corresponding to a voltage opposite in polarity to a power supply voltage, or a voltage obtained by stepping up the power supply voltage, or the like can be used. At least two linear regulators are provided. The resistive element applies the bias current to each of the linear regulators. Each of the linear regulators is provided with the output transistor.

Also, a multi-power supply method according to the present invention comprises the steps of: generating a predetermined voltage; outputting the predetermined voltage as two or more different voltage values by using linear regulators; and generating one bias current flowing via all the linear regulators.

The predetermined voltage is generated in accordance with the step for generating the predetermined voltage. The predetermined voltage is output as the two or more different voltage values using the linear regulators. At this time, one bias current flowing through all the linear regulators is generated, and hence all the linear regulators are biased by the corresponding bias current.

According to the multi-power supply circuit or the multi-power supply method, power of plural levels is supplied to a load or the like. When, for example, negative voltages of plural levels are supplied, the predetermined voltage generated at the voltage generating unit or step for generating the predetermined voltage is set as the largest voltage of the supplied negative voltages. A plurality of intermediate negative potentials between the predetermined voltage and a reference voltage such as a ground voltage are generated by the linear regulators. Thus, the negative voltages of plural levels are supplied to the load or the like.

When positive voltages of plural levels are supplied to the load or the like in like manner, the predetermined voltage is set as the largest voltage of the supplied positive voltages. In this case, the predetermined voltage may be a voltage obtained by stepping up the power supply voltage. A plurality of intermediate positive potentials are generated by the linear regulators and supplied to the load or the like.

In order to operate the linear regulators in predetermined performance and stabilize the output power, there is a need to apply bias currents to the respective linear regulators. Now consider, for example, where a bias current i is supplied. When a path for the bias current is provided for each linear regulator, the bias current consumed results in (the number of linear regulators)×(bias current i). In the multi-power supply circuit according to the present invention, however, the output transistors of the linear regulators are series-connected to the power supply path between the resistive element and the voltage generating unit. Therefore, the bias current path is shared among all the linear regulators, and the corresponding path is taken as one. In the multi-power supply method according to the present invention, the bias current is shared among all the linear regulators because one bias current flowing through all the linear regulators is generated. Thus, the consumed bias current can be set as the bias current i regardless of the number of linear regulators. Accordingly, the multi-power supply circuit and the multi-power supply method can suppress extra current consumption.

The efficiency of each linear regulator can generally be expressed in (output voltage)+(input voltage). That is, as the difference between the input/output voltages of the linear regulators becomes small, the efficiency of each linear regulator becomes high. Now consider, for example, where a plurality of linear regulators are parallel-connected to the voltage generating unit, and the voltages inputted to the linear regulators are all held constant by a predetermined voltage. At this time, the efficiency of the linear regulator is determined by a differential voltage between the predetermined voltage (the largest voltage of supplied positive/negative voltages) and a voltage output from the corresponding linear regulator.

In the multi-power supply circuit according to the present invention, however, a multistage configuration is formed wherein since the output transistors of the linear regulators are connected in series, the output voltage of the linear regulator on the voltage generating unit side is taken as the input voltage of the linear regulator on the resistive element side. And the output voltage of the linear regulator is equivalent to an intermediate potential between the predetermined voltage and the reference voltage. Thus, as compared with the potential difference between the predetermined voltage and the output voltage of the corresponding linear regulator, a potential difference between the output voltage of the pre-stage linear regulator and the output voltage of the corresponding linear regulator becomes always small. Thus, since the difference between input/output voltages of linear regulators subsequent to a second stage can be reduced and the efficiency can be enhanced, power saving of the multi-power supply circuit can be attained.

The above and further objects and novel features of the invention will more fully appear from the following detailed description when the same is read in connection with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a circuit diagram of a multi-power supply circuit according to the present invention;

FIG. 2 is a diagram showing the relationship between supply voltages Vbb0 through Vbb2 and a reference voltage GND; and

FIG. 3 is a fragmentary block diagram of an electronic device according to a related art.

### DETAILED DESCRIPTION OF THE PREFERRED EMBODIMENTS

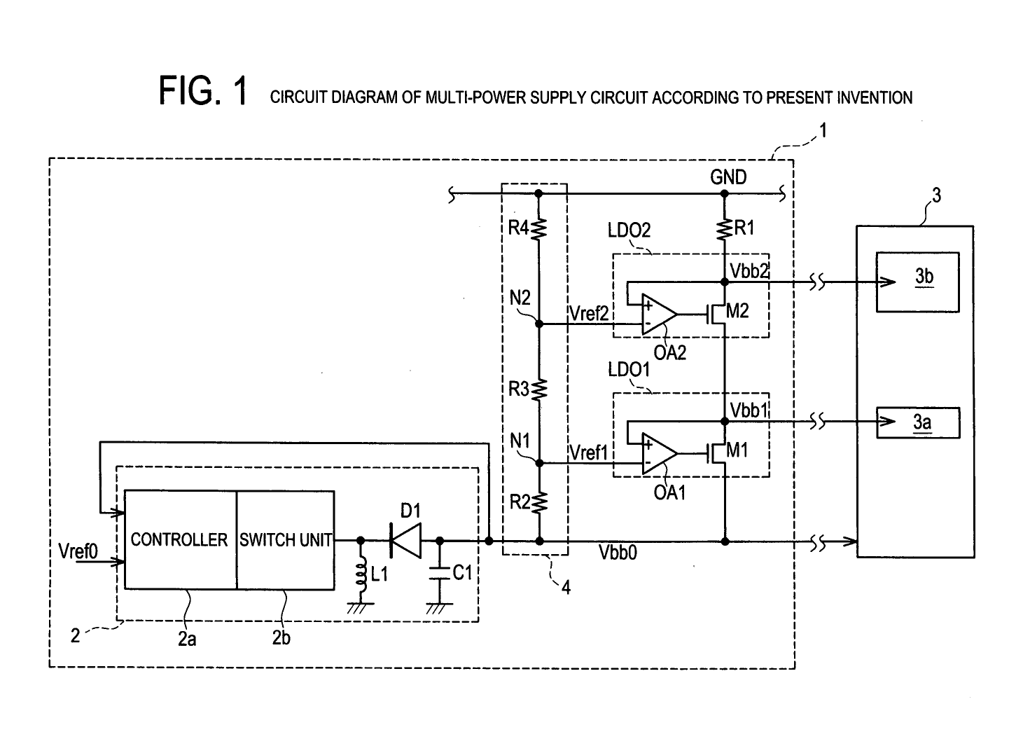

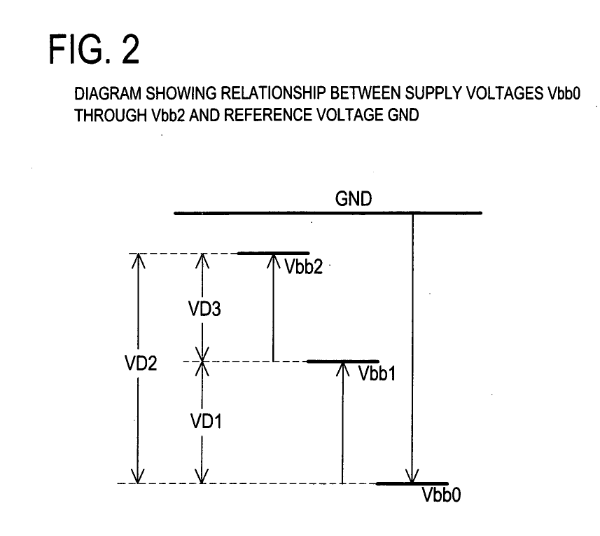

An embodiment, in which a multi-power supply circuit 1 according to the present invention is embodied, will hereinafter be described in detail based on FIGS. 1 and 2 while referring to the accompanying drawings. The multi-power supply circuit 1 according to the present invention is shown in FIG. 1. The multi-power supply circuit 1 supplies a plurality of supply voltages Vbb0 through Vbb2 to a semiconductor integrated circuit 3 that serves as a load.

The multi-power supply circuit 1 includes a DCDC converter 2, linear regulators LDO1 and LDO2, a resistive element R1 and a reference voltage generating unit 4. The supply voltages Vbb0, Vbb1 and Vbb2 are respectively output from the DCDC converter 2 and the linear regulators LDO1 and LDO2 and inputted to the semiconductor integrated circuit 3 that serves as the load. The semiconductor integrated circuit 3 is made up of a P type silicon substrate and includes blocks 3aand 3b. P-wells for the semiconductor integrated circuit 3 and the blocks 3aand 3bare biased by the supply voltages Vbb0, Vbb1 and Vbb2 corresponding to a plurality of different negative voltages (voltages opposite in polarity to a power supply voltage).

The DCDC converter 2 is of a switching regulator provided with a controller 2a, a switch unit 2b, a coil L1, a capacitor C1 and a diode D1. A reference voltage Vref0 and the supply voltage Vbb0 corresponding to the output of the DCDC regulator 2 are inputted to the controller 2a. And the supply voltage Vbb0 is output from the DCDC converter 2 and inputted to the reference voltage generating unit 4, linear regulator LDO1 and semiconductor integrated circuit 3 respectively.

The reference voltage generating unit 4 has a configuration in which resistive elements R2 through R4 are connected in series between the supply voltage Vbb0 and the reference voltage GND. Resistive division is done by the resistive elements R2 through R4. Thus, a reference voltage Vref1 is output from a node N1, and a reference voltage Vref2 is output from a node N2. Here, the resistance values of the resistive elements R2 through R4 are respectively set to high resistance values ranging from a few hundred kΩ to a few MΩ. Thus, current consumption of the reference voltage generating unit 4 can be suppressed low to a few μA or so.

The linear regulator LDO1 is equipped with an output transistor M1 and an operational amplifier OA1. A source terminal of the output transistor M1 is connected to the DCDC converter 2. A drain terminal of the output transistor M1 is connected to the linear regulator LD02 of the following stage and connected to the block 3aof the semiconductor integrated circuit 3. A voltage applied to the drain terminal of the output transistor M1 is set as the supply voltage Vbb1. The reference voltage Vref1 output from the reference voltage generating unit 4 is inputted to an inversion input terminal of the operational amplifier OA1, and the supply voltage Vbb1 is feedback-inputted to its non-inversion input terminal. An output terminal of the operational amplifier OA1 is connected to the gate of the output transistor M1.

Similarly, the linear regulator LD02 includes an output transistor M2 and an operational amplifier OA2. A source terminal of the output transistor M2 is connected to the linear regulator LDO1. A drain terminal of the output transistor M2 is connected to the resistive element R1 and connected to the block 3bof the semiconductor integrated circuit 3. A voltage applied to the drain terminal of the output transistor M2 is set as the supply voltage Vbb2. Since other configurations are similar to the operational amplifier OA1, the description thereof will be omitted here. In the output transistors M1 and M2 adjacent to each other, the size of the output transistor M1 on the DCDC converter 2 side is set equal to or greater than that of the output transistor M2 on the reference voltage GND side.

The operation of the multi-power supply circuit 1 will be explained. In the DCDC converter 2, switching duty of the switch unit 2bis adjusted according to the fed-back supply voltage Vbb0, so that a supply voltage Vbb0 having at the level corresponding to the reference voltage Vref0 is output. The supply voltage Vbb0 is of the largest negative voltage supplied to the semiconductor integrated circuit 3. Now, using a switching regulator as the DCDC converter 2 corresponding to a basic power supply source instead of a charge pump makes it possible to provide a higher efficient and high current supply capacity. Also using the switching regulator instead of the linear regulators makes it possible to generate negative voltages and a supply voltage Vbb0 obtained by boosting or stepping up a power supply voltage.

As shown in FIG. 2, supply voltages Vbb1 and Vbb2 corresponding to intermediate negative voltages between the supply voltage Vbb0 and a reference voltage GND are generated by the linear regulators LDO1 and LDO2.

The output transistor M1 of the linear regulator LDO1 is controlled by the operational amplifier OA1 and operated as a variable resistor. The supply voltage Vbb1 output from the linear regulator LDO1 is controlled to a level approximately equal to a reference voltage Vref1 inputted from the reference voltage generating unit 4. Similarly, the output transistor M2 of the linear regulator LDO2 is controlled by the operational amplifier OA2, so that the supply voltage Vbb2 is controlled to a level approximately equal to a reference voltage Vref2.

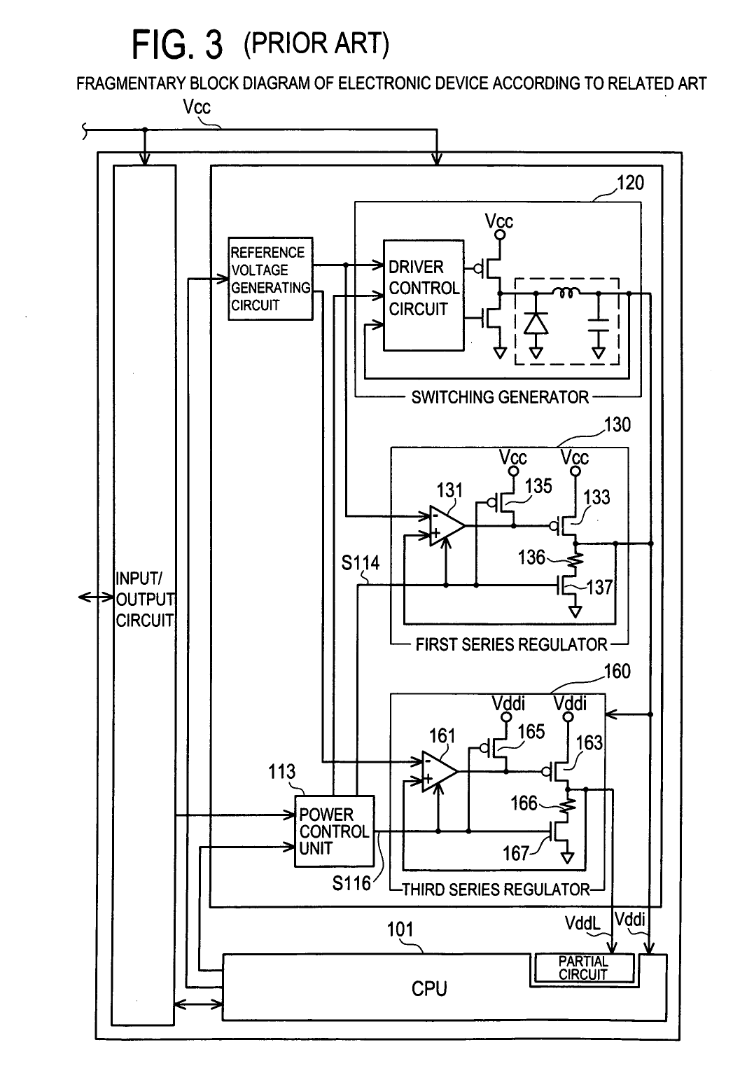

Now, in order to operate the linear regulators in predetermined performance and stabilize the output voltages of the linear regulators, there is a need to allow bias currents to flow into the respective linear regulators. The related art (see FIG. 3) will first be described here for comparison. In FIG. 3, a bias current path (resistor 136 and MOSFET 137) exists in the first series regulator 130, and a bias current path (resistor 166 and MOSFET 167) exists in the third series regulator 160. That is, the paths for the bias currents are provided every series regulators (linear regulators). In doing so, the bias current consumed or used up by the electronic device as a whole results in (the number of linear regulators)×(bias current i). A consumed total bias current value increases with the numbers of intermediate voltages to be generated and the linear regulators.

On the other hand, in the multi-power supply circuit 1 of the present invention, the output transistors M1 and M2 of the linear regulators LDO1 and LD02 are connected in series with a power supply path formed between the resistive element R1 and the DCDC converter 2. In doing so, a bias current path of the linear regulator LD02 is taken as the resistive element R1, and a bias current path of the linear regulator LDO1 is taken as the resistive element R1 and the linear regulator LD02. That is, the bias current path is shared between the linear regulators LDO1 and LD02. Hence the corresponding bias current path is taken as one. In doing so, a bias current consumed by the multi-power supply circuit 1 is held constant regardless of the number of linear regulators. It is thus possible to suppress extra current consumption of the multi-power supply circuit 1.

The efficiency of each linear regulator can generally be expressed in (output voltage of linear regulator)÷(input voltage of linear regulator). That is, as the difference between the input/output voltages of the linear regulators becomes small, the efficiency of each linear regulator becomes high. Now consider for comparison where the linear regulators LDO1 and LD02 are parallel connected to the DCDC converter 2. At this time, the voltages inputted to the linear regulators LDO1 and LD02 are both held constant by a supply voltage Vbb0 of the DCDC converter 2. In this case, the efficiency of the linear regulator LDO1 is determined by a differential voltage VD1 (see FIG. 2) between a supply voltage Vbb0 corresponding to the largest voltage of negative voltages supplied thereto and a supply voltage Vbb1 output from the linear regulator LDO1. Further, the efficiency of the linear regulator LD02 is determined by a differential voltage VD2 between the supply voltage Vbb0 and a supply voltage Vbb2 output from the linear regulator LD02.

In the present invention, however, a multistage configuration is formed wherein since the output transistors M1 and M2 are connected in series, the output voltage of the linear regulator LDO1 on the DCDC converter 2 side is taken as the input voltage of the linear regulator LD02 on the resistive element R1 side. In doing so, since the supply voltage Vbb1 output from the linear regulator LDO1 is equivalent to an intermediate potential between the supply voltage Vbb0 and the reference voltage GND, a differential voltage VD3 (differential voltage between supply voltages Vbb1 and Vbb2) becomes always smaller than a differential voltage VD2 (differential voltage between supply voltages Vbb0 and Vbb2). It is thus possible to enhance the efficiency of the linear regulator LD02 and attain low power consumption or power saving of the multi-power supply circuit.

A current path is shared between the linear regulators LDO1 and LD02. Thus, the total current of the resistive element R1 and the block 3bflows into the output transistor M2, and the total current of the output transistor M2 and the block 3aflows into the output transistor M1. That is, the output transistor of the stage near the DCDC converter 2 corresponding to the current supply source can supply more current. In the multi-power supply circuit 1 according to the present invention, the size of the output transistor M1 is set greater than that of the output transistor M2, and the output transistor of the stage near the DCDC converter 2 is configured such that the current supply capacity of the transistor becomes larger. It is thus possible to prevent the occurrence of such an event that the power supply capacity of the multi-power supply circuit 1 lacks due to a lack of capacity of each output transistor.

In the multi-power supply circuit according to the present embodiment, as described above in detail, a bias current path is shared among a plurality of linear regulators, and the corresponding path is taken as one. Thus, since the bias current consumed by the multi-power supply circuit is set to a constant value regardless of the number of linear regulators, extra current consumption of the multi-power supply circuit can be suppressed.

The multi-power supply circuit according to the present embodiment is formed with a multistage configuration wherein since output transistors of linear regulators are connected in series, a voltage output from the linear regulator on the voltage generating unit side is taken as a voltage inputted to the linear regulator on the resistive element side. Thus, since a differential voltage between input/output voltages can be reduced at each linear regulator subsequent to a second stage, the efficiency of the corresponding linear regulator can be enhanced and power saving of the multi-power supply circuit can be attained.

In the multi-power supply circuit according to the present embodiment, a current path is shared among a plurality of linear regulators, and an output transistor of a stage near a voltage generating unit corresponding to a current supply source can supply more current. The output transistor of the stage near the voltage generating unit is configured in such a manner that the current supply capacity of the transistor becomes larger. It is thus possible to prevent the occurrence of such an event that the power supply capacity of the multi-power supply circuit 1 lacks due to a lack of capacity of the output transistor.

Incidentally, the present invention is not limited to the embodiment referred to above. It is needless to say that various changes and modifications can be made thereto within the scope not departing from the gist thereof. Although the supply voltage Vbb0 generated at the DCDC converter 2 is set to the negative voltage (the voltage opposite in polarity to the power supply voltage) in the present embodiment, the present invention is not limited to this embodiment. The supply voltage may be a positive voltage or a voltage obtained by boosting the power supply voltage. Even in this case, the configuration of the multi-power supply circuit 1 can make use of one similar to the case of the negative voltage and the direction of current becomes opposite. It is possible to generate a plurality of intermediate positive potentials between the positive voltage and the reference voltage and supply the same to a load or the like. As an example of use of the acquired plural intermediate positive potentials, may be mentioned, the use thereof for substrate biases of N-wells in the semiconductor integrated circuit.

Although the two linear regulators are provided in the present embodiment, the present invention is not limited to this embodiment. Further, it is needless to say that power having a larger number of levels can be supplied by connecting a larger number of linear regulators in series. The advantageous effect of the present invention that as the number of linear regulators increases, a bias current path between the linear regulators is taken as one for sharing therebetween Further, extra current consumption can be suppressed.

Although the present embodiment shows the form in which the switching regulator is used as the DCDC converter 2 corresponding to the voltage generating unit in FIG. 1, the present invention is not limited to this form. For instance, a charge pump may be used. It is needless to say that this can bring about a similar effect. Incidentally, the charge pump in this case needs to have an ability to be capable of sufficiently supplying currents consumed by the linear regulators LDO1 and LD02 and the resistive element R1.

Incidentally, the supply voltage Vbb0 is one example of a predetermined voltage and the DCDC converter 2 is one example of a voltage generating unit, respectively.

According to the multi-power supply circuit of the present invention using the linear regulators and the multi-power supply method therefor, a consumed bias current can be kept constant regardless of the number of the linear regulators. Therefore, extra current consumption can be suppressed. Since the multi-power supply circuit has a multistage configuration wherein a voltage output from the linear regulator on the voltage generating unit side is taken as a voltage inputted to the linear regulator on the resistive element side, the efficiency of each linear regulator subsequent to the second stage can be enhanced and power saving-can be attained.

What is claimed is:

1. A multi-power supply circuit comprising:
a voltage generating unit for generating a predetermined voltage;
at least two linear regulators; and
a resistive element for applying a bias current to each of the linear regulators,
wherein output transistors provided in the linear regulators are series-connected to a power supply path between the resistive element and the voltage generating unit.

2. The multi-power supply circuit according to claim 1, wherein each of the linear regulators includes the output transistor and an operational amplifier which is inputted with a voltage of the output transistor at a terminal on the resistive element side and a reference voltage, the operational amplifier of which an output is inputted to a gate of the output transistor.

3. The multi-power supply circuit according to claim 1, wherein the size of the output transistor on the voltage generating unit side, of the output transistors adjacent to each other is equal to or greater than that of the output transistor thereof on the resistive element side.

4. The multi-power supply circuit according to claim 1, wherein the voltage generating unit is a switching regulator or a charge pump.

5. A multi-power supply method comprising the steps of:
generating a predetermined voltage;
outputting the predetermined voltage as different voltage values by using linear regulators; and
generating one bias current flowing via all the linear regulators.
